(19) United States
(12) Patent Application Publication
(10) Pub. No.: US 2007/0222198 A1
(43) Pub. Date: Sep. 27, 2007

(54) Multi-firing combustion actuated device and related methods for firing re-deployable automotive safety devices

(76) Inventors: David J. Green, Brigham City, UT (US); Guy Letendre, Ogden, UT (US); Brent Parks, Englewood, CO (US)

Correspondence Address: AUTOLIV ASP INC, 3350 AIRPORT ROAD, OGDEN, UT, 84405, US

(21) Appl. No.: 11/387,584

(22) Filed: Mar. 23, 2006

(51) Int. Cl. B60R 21/04

(52) U.S. Cl. 280/753; 280/752

(57) ABSTRACT

Disclosed are embodiments of a multi-firing combustion actuated device for use in automotive safety. The device comprises a combustion actuator and a re-deployable automotive safety component. The actuator is adapted for directing a force from combustion to the automotive safety component.

### TECHNICAL FIELD

The present invention relates generally to the field of automotive protective systems. More specifically, the present invention relates to a combustion device for actuating automotive safety devices.

### BRIEF DESCRIPTION OF THE DRAWINGS

Understanding that drawings depict only typical embodiments of the invention and are not therefore to be considered limiting of its scope, the invention will be described and explained with additional specificity and detail through the use of the accompanying drawings in which:

FIG. 1 is a cross-sectional view of one embodiment of a multi-firing combustion actuated device, comprising an actuator and a knee bolster automotive safety component, mounted in an instrument panel of a vehicle.

FIG. 2A is a cross-sectional view of one embodiment of a multi-firing combustion actuated device shown prior to firing. A multi-firing actuator is coupled with a block representation of a re-deployable automotive safety component. In this embodiment, force generated from combustion is transferred to the automotive safety component via the combustion exhaust.

FIG. 2B is a cross-sectional view of the embodiment shown in FIG. 2A immediately after the actuator has fired.

FIG. 3A is a cross-sectional view of another embodiment of a multi-firing combustion actuated device shown prior to firing. In this embodiment, force generated from combustion is transferred from the actuator to the automotive safety component through a piston pushing a fluid. The fluid may be separate from the combustion exhaust.

FIG. 3B is a cross-sectional view of the embodiment shown in FIG. 3A immediately after the actuator has fired.

FIG. 4A is a cross-sectional view of still another embodiment of a multi-firing combustion actuated device shown prior to firing. In this embodiment force generated from combustion is transferred to the automotive safety component through a shaft extending from a piston that is driven by force generated from combustion.

FIG. 4B is a cross-sectional view of the embodiment shown in FIG. 4A immediately after the actuator has fired.

FIG. 5A is a cross-sectional view of an embodiment of an automotive safety component as used in combination with an actuator, which is shown in block representation. The automotive safety component is a knee bolster automotive safety device with a telescoping mechanism. The automotive safety component is shown immediately prior to the actuator firing.

FIG. 5B is a cross-sectional view of the automotive safety component shown in FIG. 5A in combination of an actuator. The automotive safety component is shown immediately after the actuator has fired.

### DETAILED DESCRIPTION OF PREFERRED EMBODIMENTS

Described below are embodiments of a multi-firing combustion actuated device. A multi-firing combustion actuated device comprises a multi-firing actuator in combination with a re-deployable automotive safety component. Three embodiments of a multi-firing combustion actuator, for use with automotive safety components, are specifically described with reference to the figures. In one embodiment, force for actuating an automotive safety component is transferred from the actuator via exhaust from combustion of fuel in a chamber of the actuator. In another embodiment, force for actuating an automotive safety device is transferred from the actuator via fluid. The fluid is pushed with a piston driven by combustion exhaust. In still another embodiment, force for actuating an automotive safety device is transferred from the actuator via an extension, such as a shaft, from a piston driven by combustion exhaust.

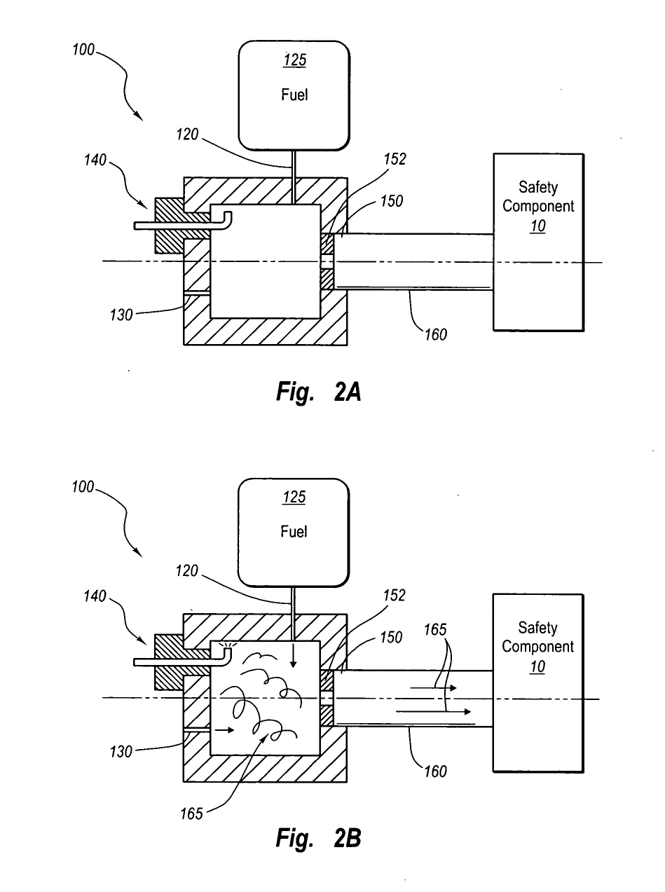

With reference to the accompanying figures, embodiments of the invention will now be described in greater detail. The different embodiments of an actuator are shown respectively in FIGS. 2A-2B, FIGS. 3A-3B and FIGS. 4A-4B. Other embodiments are also within the scope of the claims based on the accompanying description.

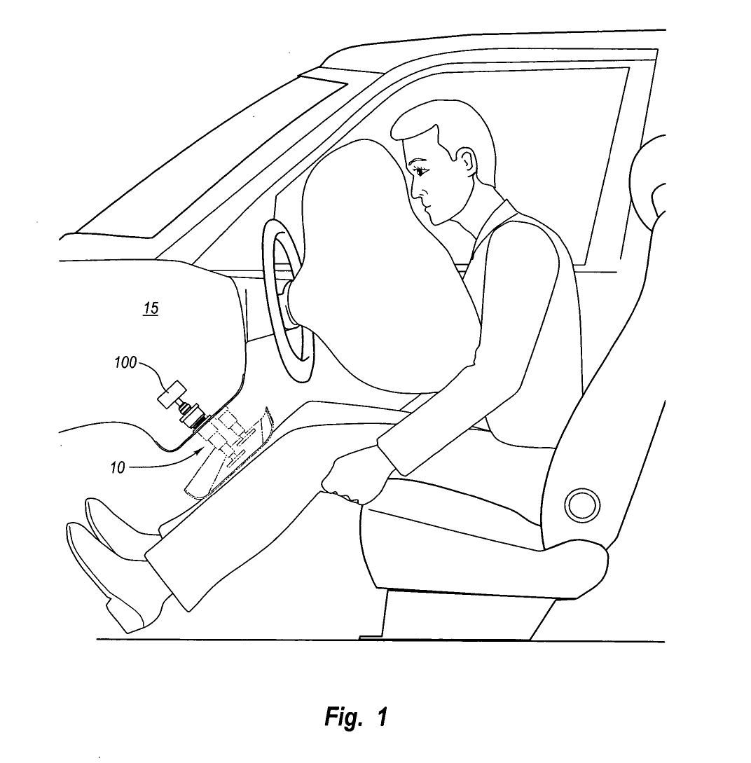

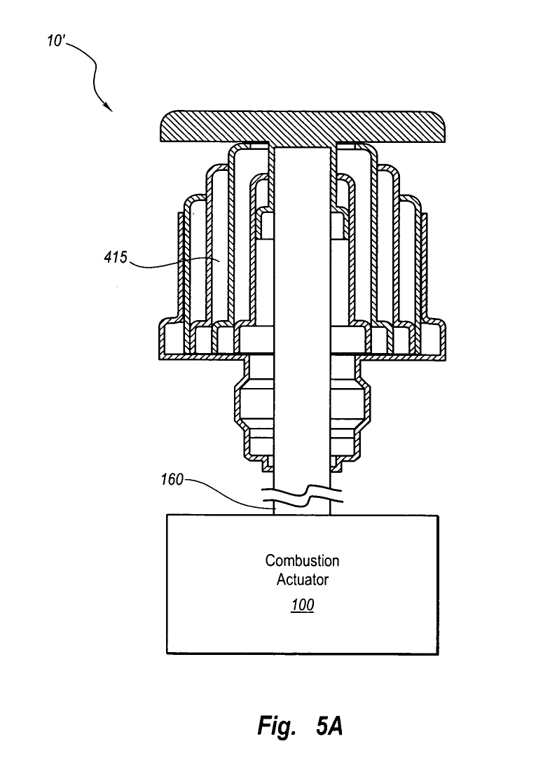

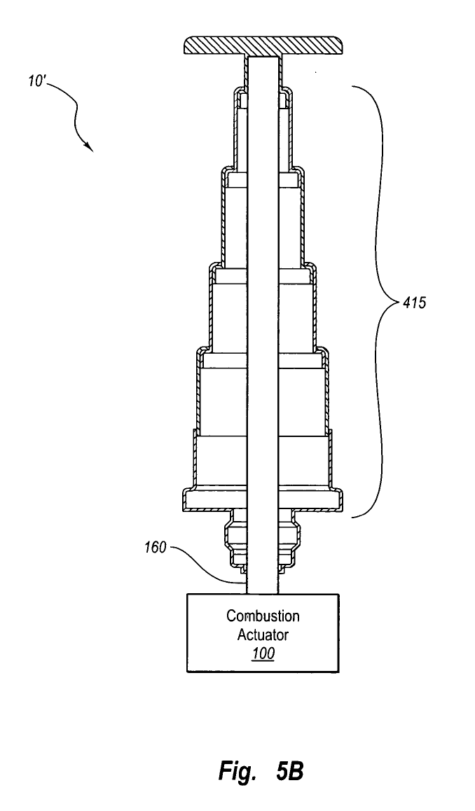

FIG. 1 and FIGS. 5A-5B schematically depict an actuator in combination with an automotive safety component. While the embodiment of the re-deployable automotive safety component depicted is a knee protective telescoping pyrotechnic device many other automotive safety components may be utilized in combination with an actuator. For example, the automotive safety component may be an engine hood of a vehicle. A hood in use with the actuator permits the actuator to raise the hood to protect a pedestrian from impacting the car's engine when the hood collapses down.

In FIG. 1, an embodiment of a multi-firing combustion actuated device, comprising actuator 100 and automotive safety component 10′, is shown installed in an instrument panel 15 of an automobile. Automotive safety component 10′, referred to more generally in other portions of this application as automotive safety component 10, is depicted in this embodiment as a knee protective telescoping pyrotechnic device. Such knee protective telescoping pyrotechnic devices and other telescoping pyrotechnic devices have been disclosed and described in greater detail in copending U.S. patent application Ser. No. 11/127,665 filed May 11, 2005 and titled “Pyrotechnic Safety Device With Retractable Telescoping Mechanism.” Actuator 100 is automatically re-usable to deploy automotive safety component 10′. In other words, actuator 100 does not need to be replaced after firing, and does not require a technician to reset it for subsequent firings after a collision.

In FIGS. 2A-2B, cross-sectional views of an embodiment of multi-firing actuator 100 are shown in conjunction with a block representation of an automotive safety component 10. The embodiment of the actuator shown at 100 comprises a combustion chamber 110, a fuel inlet 120, an air inlet valve 130 to allow air into combustion chamber 110, an igniter 140 extending into combustion chamber 110, an outlet 150 through which the exhaust from combustion is directed. Actuator 100 also comprises a coupler 160 for directing the exhaust to the automotive safety component 10. Fuel inlet 120 allows fuel tank 125 to be in fluid communication with combustion chamber 110. The embodiment of the outlet shown at 150 has a relatively small diameter. Outlet 150 is defined by flow restrictor 152. Coupler 160 is configured to connect with the automotive safety component 10. FIG. 2A shows actuator 100 prior to firing. When the force of a collision or some other stimulus triggers the igniter, fuel and air in combustion chamber 110 ignite. FIG. 2B shows actuator 100 during combustion, with combustion exhaust 165 delivering a force to automotive safety component 10. Exhaust 165 generated from combustion is directed by outlet 150, through flow restrictor 152 and coupler 160, to automotive safety component 10.

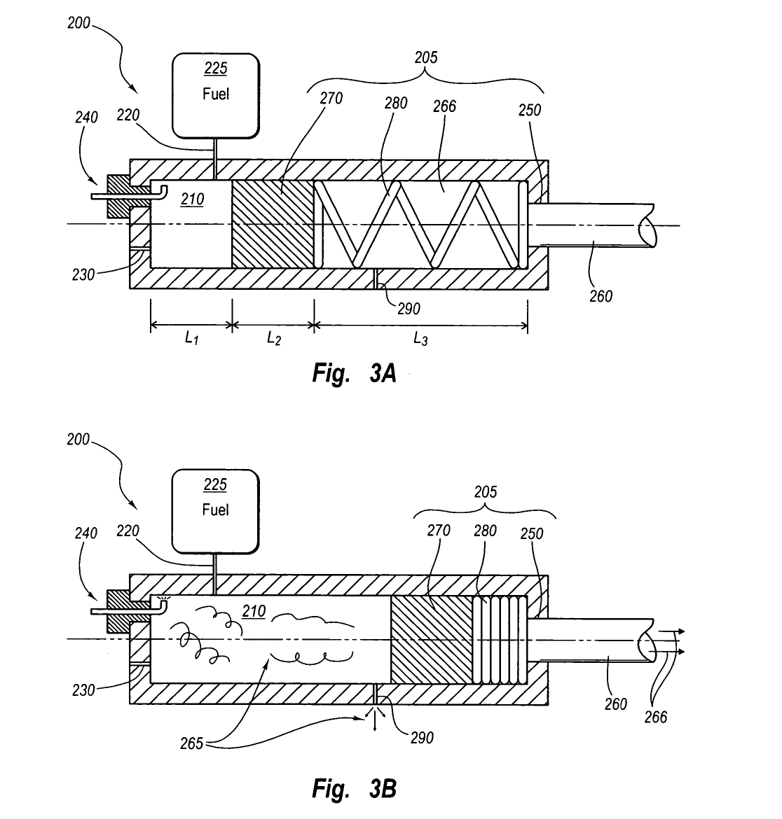

In FIGS. 3A-3B, cross-sectional views of a second embodiment of a multi-firing actuator 200 are shown. Similar to the embodiment of the actuator shown in FIGS. 2A-2B at 100, the embodiment of the actuator shown at 200 comprises a combustion chamber 210, a fuel inlet 220 allowing fluid communication between a fuel tank 225 and a combustion chamber 210, an air inlet valve 230 to allow air into combustion chamber 210, and an igniter 240 extending into combustion chamber 210. Actuator 200 also comprises an exhaust vent 290, a coupler 260 positioned to a direct fluid 266, and a driver 205, which in the depicted embodiment comprises a piston 270, a fluid 266, a biasing component 280, and an outlet 250. Piston 270 is movably positioned in combustion chamber 210. Fluid 266 may be a gas or a liquid and may be separate from the air consumed during combustion and/or the combustion exhaust 265 generated within chamber 210. Piston 270 is of length L2 and is positioned length L1 from one wall of the combustion chamber and length L3 from the opposite wall. Fuel inlet 220, air inlet 230 and igniter 240 are within the space of length L1. Outlet 250 is on the wall at the end of length L3 opposite piston 270. Driver 205 is shaped and configured such that the force from combustion pushes piston 270, thereby forcing fluid 266 through outlet 250 and transferring the force of combustion via fluid 265 to an automotive safety component (not shown). During combustion length L1 increases and length L3 decreases as the force from combustion drives piston 270. Outlet 250 may be an orifice in a flow restrictor or it may have the same diameter as coupler 260. After combustion, exhaust 266 generated from combustion escapes through exhaust vent 290. Biasing component 280, depicted as a spring, is positioned and configured to return piston 270 to its pre-combustion position. Driver 205 is shaped and configured to refill with fluid 266 when biasing component 280 returns piston 270 to its pre-combustion position. Note that the relative ratios of the lengths, L1, L2 and L3 may have different values from those shown based on the desired design.

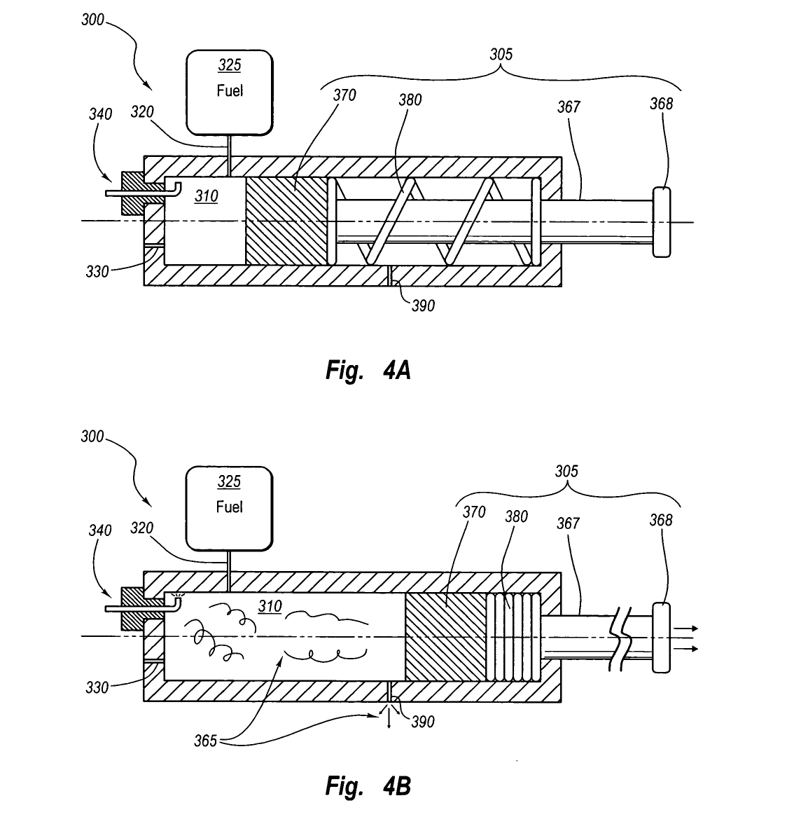

In FIGS. 4A-4B, cross-sectional views of a third embodiment of an actuator for a multi-firing combustion actuated device are shown at 300. Similar to actuator 100 shown in FIGS. 2A-2B and actuator 200 shown in FIGS. 3A-3B, actuator 300 comprises a combustion chamber 310, a fuel inlet 320 allowing fluid communication between fuel tank 325 and combustion chamber 310, an air inlet valve 330 to allow air into combustion chamber 310, and an igniter 340 extending into combustion chamber 310. Similar to actuator 200, actuator 300 further comprises an exhaust vent 390 and a driver 305, comprising a piston 370, which is movably positioned in the combustion chamber 310. Unlike the previously disclosed embodiments, driver 305 further comprises a directing element 367, which is attached to piston 370 and extends outside chamber 310 for delivering the force of combustion to an automotive safety component. Directing element 367 may be configured with a head 368, as shown in FIGS. 4A-4B, to strike or push the automotive safety component (not depicted), or configured to directly connect with the automotive safety component. Driver 305 is shaped such that the force from combustion pushes piston 370, drives directing element 367, and transfers the force of combustion to an automotive safety component (not depicted) via directing element 367 and the head 368. Following combustion, exhaust 365 generated by combustion escapes through exhaust vent 390. A biasing component 380, depicted as a spring, returns piston 370 and directing element 367 to their pre-combustion position.

In FIGS. 5A-5B, cross-sectional views of a re-deployable automotive safety component 10′ are shown. Automotive safety component 10′ is shown in conjunction with a block representation of an embodiment of a multi-firing actuator, 100. Automotive safety component 10′ is a knee protective telescoping pyrotechnic device. In FIG. 5A, automotive safety component 10′ is shown prior to deployment. In other words, multi-firing combustion actuated device 100 has not fired. In FIG. 5B, automotive safety device 10′ is shown fully deployed. Actuator 100 has fired and the force of combustion has been transferred via exhaust from combustion through coupler 160 to automotive safety component 10′, extending the telescoping mechanism 415 of the knee protective automotive safety component 10′.

Automotive safety component 10 and automotive safety component 10′ are examples of means for protecting an automobile occupant. Automotive safety component 10 and automotive safety component 10′ are re-deployable. Actuators 100, 200, and 300 are examples of means for actuating an automotive safety device. Chambers 110, 210, and 310 are examples of a means for combusting fuel and air. Fuel inlets 120, 220, and 320 are examples of a means for providing fluid communication between a fuel source and the chamber means. Air inlets 130, 230, and 330 are examples of means for allowing air for combustion to the chamber means. Igniters 140, 240, and 340 are examples of a means for initiating combustion in the chamber means. Outlets 150 and 250 and directing element 367 are examples of a means for directing the force of combustion to the automotive safety component.

Without further elaboration, it is believed that one skilled in the art can use the preceding description to utilize the invention to its fullest extent. The examples and embodiments disclosed herein are to be construed as merely illustrative and not a limitation of the scope of the present invention in any way. It will be apparent to those having skill in the art that changes may be made to the details of the above-described embodiments without departing from the underlying principles of the invention. In other words, various modifications and improvements of the embodiments specifically disclosed in the description above are within the scope of the appended claims. The scope of the invention is therefore defined by the following claims. Note also that elements recited in means-plus-function format are intended to be construed in accordance with 35 U.S.C. §112 ¶6.

1. A multi-firing combustion actuated device, comprising:
a re-deployable automotive safety component;
an actuator comprising
a combustion chamber;
a fuel inlet valve in fluid communication with the chamber;
an air inlet valve in fluid communication with the chamber;
an igniter positioned to initiate combustion in the chamber;
an outlet positioned to direct a force generated from combustion of a fuel within the chamber to the automotive safety component.

2. The device of claim 1, wherein the actuator is automatically re-usable to deploy the automotive safety component in a subsequent collision.

3. The device of claim 1, further comprising a fuel source in fluid communication with the chamber via the fuel inlet valve.

4. The device of claim 1, wherein the force generated from combustion is transferred to the automotive safety component via the exhaust of combustion.

5. The device of claim 1, wherein the force generated from combustion drives a piston, which transfers the force to the automotive safety component via a fluid separate from the exhaust from combustion.

6. The device of claim 1, wherein the force generated from combustion drives a piston, and wherein the piston transfers the force to the automotive safety component via a shaft extending from the piston outside the chamber.

7. The device of claim 6, wherein the shaft is connected with the automotive safety component.

8. The device of claim 7, wherein the shaft is attached to the automotive safety component.

9. The device of claim 6, wherein the shaft is configured to strike the automotive safety component.

10. A multi-firing combustion actuated device, comprising:
a re-deployable automotive safety component; and
an actuator comprising
a combustion chamber;
a fuel inlet valve in fluid communication with the chamber;
an air inlet valve in fluid communication with the chamber;
an igniter positioned to initiate combustion in the chamber; and
an outlet positioned to direct exhaust from combustion of fuel within the chamber to the automotive safety component;

11. The device of claim 10, further comprising a fuel source in fluid communication with the chamber via the fuel inlet valve.

12. The device of claim 10, wherein the outlet directing the exhaust from combustion is an orifice configured and positioned to transfer force from the combustion of the fuel to the automotive safety device via the exhaust.

13. The device of claim 12, further comprising a coupler around the orifice to direct the exhaust.

14. A multi-firing combustion actuated device, comprising:
a re-deployable automotive safety component;
an actuator comprising:
a combustion chamber;
a fuel inlet valve in fluid communication with the chamber;
an air inlet valve in fluid communication with the chamber;
an igniter positioned to initiate combustion in the chamber;
a driver comprising:
a piston movably positioned in the chamber of the actuator such that the force from an explosion in the chamber moves the piston;
an outlet positioned to direct a fluid out of the chamber, the fluid being located between the piston in the chamber and the outlet, such that the force from combustion of the fuel is directed out of the outlet via the fluid; and
a biasing component that returns the driver to its pre-combustion position in the chamber after combustion; and
an outlet positioned to vent exhaust in the space between the igniter and the piston after combustion of the fuel.

15. The device of claim 14, further comprising a fuel source in fluid communication with the chamber via the fuel inlet valve.

16. The device of claim 14, wherein the fluid directing force to the automotive safety component is separate from the exhaust from combustion.

17. The device of claim 14, wherein the biasing component comprises a spring.

18. The device of claim 14, wherein the fluid is a gas.

19. The device of claim 14, wherein the fluid is a liquid.

20. The device of claim 14, wherein the fluid directing the force of combustion to the automotive safety component is directed via an orifice shaped to direct the fluid in a way that transfers the force of combustion to the automotive safety device via the fluid.

21. The device of claim 20, further comprising a coupler around the orifice to direct the fluid to transfer the force to the automotive safety component.

22. A multi-firing combustion actuated device, comprising:
a re-deployable automotive safety component;
an actuator comprising:
a combustion chamber;
a fuel inlet valve in fluid communication with the chamber;
an air inlet valve in fluid communication with the chamber;
an igniter positioned to initiate combustion in the chamber;
a driver comprising:
a piston movably positioned in the chamber such that a force from an explosion in the chamber moves the piston;
a directing element extending outside the chamber for delivering the force of combustion to the automotive safety component; and
a biasing component that returns the piston to its pre-combustion position in the chamber after combustion; and
an outlet positioned to vent exhaust in the space between the igniter and the driver after combustion of the fuel.

23. The device of claim 22, further comprising a fuel source in fluid communication with the chamber via the fuel inlet valve.

24. The device of claim 22, wherein the biasing component comprises a spring.

25. The device of claim 22, wherein the directing element comprises a shaft connected with the piston.

26. The device of claim 25, wherein the shaft is configured to make impact with the automotive safety device for transferring a force generated by combustion to the automotive safety device.

27. The device of claim 25, wherein the shaft is configured to connect with the automotive safety device.

28. A multi-firing combustion actuated device comprising:
means for protecting an automobile occupant, wherein the protecting means is re-deployable; and
means for actuating the protecting means, wherein the actuating means comprises;
chamber means for combusting fuel and air;
fuel inlet means for providing fluid communication between a fuel source and the chamber means;
air inlet means for enabling air to reach the chamber means;
igniter means for initiating combustion of fuel and air in the chamber means;
outlet means for directing a force generated by combustion within the chamber means to the protecting means.

29. A method for actuating a re-deployable automotive safety device comprising:
obtaining a repeated-use combustion actuated device comprising:
a re-deployable automotive safety component; and
an actuator adapted for directing a force from combustion of a fuel to the automotive safety component; and
resetting the automotive safety device after deployment for subsequent deployment.

30. The method as in claim 29, wherein the force is directed to the automotive safety device via exhaust generated from combustion.

31. The method as in claim 30, wherein the combustion actuated device further comprises an orifice shaped to direct the exhaust from combustion to the automotive safety device.

32. The method as in claim 29, wherein the force is directed to the automotive safety device via a fluid which is separate from exhaust generated from combustion.

33. The method as in claim 32, wherein the exhaust drives a piston, which pushes the fluid to transfer the force to the automotive safety device.

34. The method as in claim 29, wherein the force is directed to the automotive safety device via a mechanism for transferring force.

35. The method as in claim 34; wherein the mechanism for transferring force is a piston driven by exhaust from combustion.

36. The method as in claim 35, wherein the force is applied to the automotive safety device by a shaft extending from the piston.
